(19) United States
(12) Patent Application Publication
(10) Pub. No.: US 2013/0094515 A1
(43) Pub. Date: Apr. 18, 2013

(54) SYSTEMS, APPARATUS, AND METHODS FOR REMOVING DUPLICATE DATA PACKETS FROM A TRAFFIC FLOW OF CAPTURED DATA PACKETS TRANSMITTED VIA A COMMUNICATION NETWORK

(71) Applicants: Nils Gura, Daly City, CA (US); Lalit Chaudhari, Fremont, CA (US); Peter Vinsel, Oakland, CA (US); David Kucharczyk, Santa Fe, NM (US)

(72) Inventors: Nils Gura, Daly City, CA (US); Lalit Chaudhari, Fremont, CA (US); Peter Vinsel, Oakland, CA (US); David Kucharczyk, Santa Fe, NM (US)

(21) Appl. No.: 13/601,793

(22) Filed: Aug. 31, 2012

Related U.S. Application Data
(60) Provisional application No. 61/529,802, filed on Aug. 31, 2011.

(51) Int. Cl. H04L 12/56

(52) U.S. Cl. CPC H04L 47/00
USPC 370/419

(57) ABSTRACT

Systems, apparatus, and methods for removing duplicate data packets from a traffic flow of captured data packets transmitted via a communication network may generate a secure hash signature for a captured data packet included in a traffic flow of captured data packets. The secure hash signature may be transmitted to a memory controller. The memory controller may compare the received secure hash signature with one or more previously generated secure hash signatures stored in a memory and transmit a control signal to a switch responsively to the comparison The switch may then transmit, or not transmit, the captured data packet to an egress port for eventual transmission to an external device responsively to the received control signal.

### RELATED APPLICATION

This patent application is a NONPROVISIONAL of, and claims priority to, and incorporates by reference U.S. Provisional Patent Application 61/529,802, filed 31 Aug. 2012.

### FIELD OF INVENTION

The present invention relates to systems, apparatus, and methods for removing duplicate data packets from a traffic flow of captured data packets transmitted via a communication network.

### BACKGROUND

Duplicate data packets can be introduced into a traffic flow of captured data packets in a variety of ways and for a variety of purposes. In some cases, duplicate data packets are a by-product of certain operations that are performed on the traffic flow of captured data packets by a network captured traffic distribution device or network tap, such as the aggregation of data packets from a variety of sources and the filtering of data packets under according to criteria and/or by various filtering devices. Such duplicate packets, when passed along to network analysis or monitoring equipment from the network captured traffic distribution device or network tap, can cause the network analysis/monitoring equipment to malfunction and decrease throughput.

### SUMMARY

Systems, apparatus, and methods for removing duplicate data packets from a traffic flow of captured data packets transmitted via a communication network are herein provided. One exemplary apparatus is a network captured traffic distribution device. The network captured traffic distribution device may include an ingress port, an egress port, a memory, a processor, a memory controller, and a switch communicatively coupled to one another. On some occasions, the ingress port and the egress port may be combined into a single bi-directional port. The ingress port may be configured to receive a traffic flow of captured data packets from a source of captured data packets and transmit the traffic flow of captured data packets to a processor. The egress port may be configured to receive captured data packets from the processor and transmit captured data packets from the network captured traffic distribution device toward an external device (e.g., a network monitor or analysis device) via a communication network. On some occasions, the network captured traffic distribution device may include a packet detector configured to detect when a captured data packet is received by the ingress port and transfer the detected captured data packet to the processor.

The memory may include, for example, content-addressable memory (CAM), dynamic random-access memory (DRAM), and/or static random-access memory (SRAM) and may be configured to store previously generated secure hash signatures. The processor may be configured to, for example, receive captured data packets from the ingress port, generate a secure hash signature for a captured data packet included in the traffic flow, and transmit the secure hash signature to the memory controller. The secure hash signature may include a secret key.

The memory controller may be configured to received the secure hash signature from the processor, compare received secure hash signature with the previously generated secure hash signatures stored in the memory, and transmit a control signal to a switch responsively to the comparison. On some occasions, the network captured traffic distribution device may include a buffer configured to buffer the traffic flow of received captured data packets prior to receipt by the memory controller.

The switch may be configured to receive the control signal from the memory controller and transmit the captured data packet to the egress port responsively to the received control signal. In some embodiments, the network captured traffic distribution device may include a filter configured to filter the captured data packets according to at least one criterion.

In some embodiments, the network captured traffic distribution device may be a component of a system including an external data storage device configured to store previously generated secure hash signatures. The external data storage device may include content-addressable memory (CAM), dynamic random-access memory (DRAM), and/or static random-access memory (SRAM).

An exemplary method provided herein includes receiving a traffic flow of captured data packets, wherein the captured data packets are received via at least one of a mirror port resident on a source of the captured data packets and a traffic capture point located along a communication link between two communicating devices, generating a secure hash signature for a captured data packet included in the traffic flow, the secure hash signature including a secure key, comparing the generated secure hash signature with stored secure hash signatures, and transmitting the captured data packet toward an external device responsively to the comparison. The secure hash signature may be generated based upon, for example, the contents of at least one of the entire packet and a portion of the packet. The traffic flow of received captured data packets may be buffered prior to the generation of the secure hash signature and/or the comparison. In some embodiments capture data packets may be filtered according to one or more criterion.

### BRIEF DESCRIPTION OF THE DRAWINGS

The present invention is illustrated by way of example, and not limitation, in the figures of the accompanying drawings in which:

FIGS. 1 is a block diagram depicting exemplary network communication system, in accordance with embodiments of the present invention;

FIGS. 2A, 2B, and 2C are block diagrams depicting exemplary network captured traffic distribution devices, in accordance with embodiments of the present invention; and

FIG. 3 is a flow chart depicting an exemplary process for removing duplicate data packets from a traffic flow of data packets transmitted via a communication network, in accordance with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### Written Description

Network monitoring and analysis equipment typically operates by analyzing captured data packets, or portions thereof. A traffic flow of captured data packets is often delivered to the network monitoring and analysis equipment via a network captured traffic distribution device or network tap. This traffic flow may include duplicate captured data and removal of such duplicate captured data packets from the traffic flow of captured data packets forwarded to the network monitoring and analysis equipment as described herein may, for example, improve the operational effectiveness and efficiency of the network monitoring and analysis equipment.

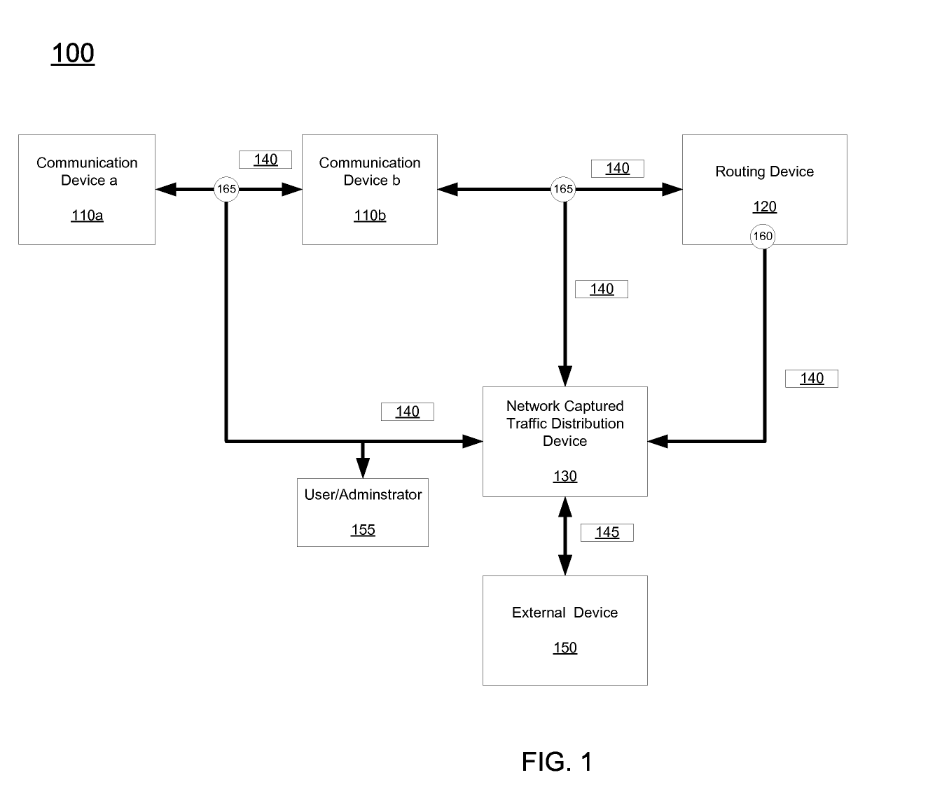

FIG. 1 is block diagram depicting a network communication system 100 in which one or more of the processes disclosed herein may be executed. System 100 may be, for example, any packet switched communication network, such as a telecommunication system, a Code Division Multiple Access (CDMA) system, a system compliant with the IEEE 802.1 Q standard for configuring virtual LANs (VLAN), or a system enabled to transmit and/or receive data packets including VLAN tags. System 100 may also be a virtual communication network, a cloud-computing network, a local area network (LAN), or a wireless LAN (WLAN).

The components of system 100 may be communicatively coupled to one another via one or more communication links. The communication links may be any conventionally available communication link, such as a wireless link, or a wired link such as an Ethernet cable, a 10/100 Ethernet cable, a 1-gigabit Ethernet cable, a 10-gigabit Ethernet cable, a copper cable, and an optical fiber cable.

System 100 may include two communication devices 110a and 110b communicatively coupled to one another. Exemplary communication devices 110a and 110b include personal computers, mobile computing devices, server computers, and mobile telephones. Communication device 110a may generate a data packet 140 and transmit data packet 140 to communication device 110b and/or a routing device, such as routing device 120, via a communication link. Routing device 120 may be any router enabled to route data packets 140 through communication system 100. Communication device 110a may also receive a data packet 140 from communication device 110b via a communication link.

System 100 may also include a network captured traffic distribution device 130, which may be any network captured traffic distribution device capable of receiving captured network traffic (e.g., a network tap). Network captured traffic distribution device 130 may include a plurality of ports by which the network captured traffic distribution device may communicate with another device included in system 100 and may receive and/or transmit captured traffic. In some cases, a port may be a monitor port or a stacking port. Network captured traffic distribution device 130 may also be communicatively coupled so as to provide information to and/or receive instructions from a user and/or administrator 155. User/administrator 155 may be, for example, a user and/or administrator of, for example, system 100 and/or network captured traffic distribution device 130.

Network captured traffic distribution device 130 may be communicatively coupled to a mirror port 160 present on routing device 120 via a port and may receive a traffic flow of captured data packets, including data packet 140, from routing device 120 via mirror port 160. Network captured traffic distribution device 130 may also be communicatively coupled to a traffic capture point 165 located along a communication link between communication device 110a and routing device 120 and/or between communication devices 110a and 110b and thereby may captured data packets, like data packet 140, via an inline network traffic capture at traffic capture point 165.

Network captured traffic distribution device 130 may communicate a captured data packet 145 to an external device 150 via, for example, a port. External device 150 may include multiple input/output ports that may operate in duplex or half-duplex mode. Exemplary external devices 150 include network monitors and network analyzing devices. Network captured traffic distribution device 130 may further be configured to generate a secure hash signature for captured data packet 140 and may use the generated secure hash signatures to remove duplicate captured data packets from a traffic flow of captured data packets.

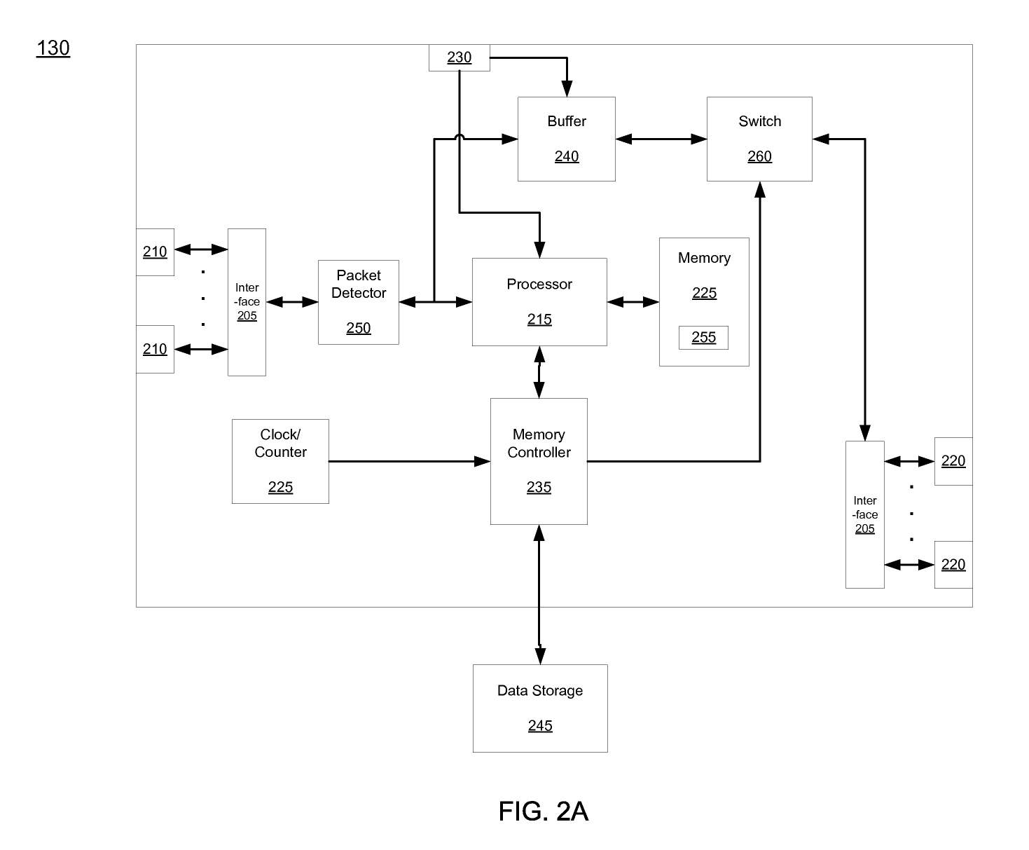

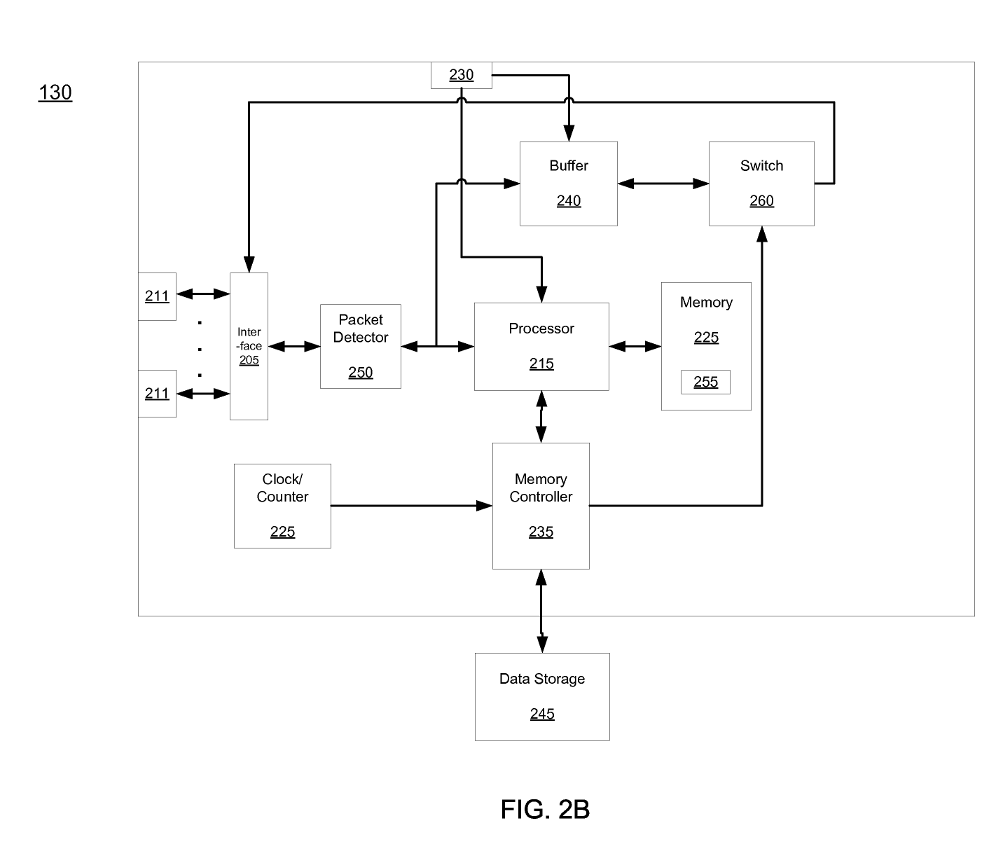

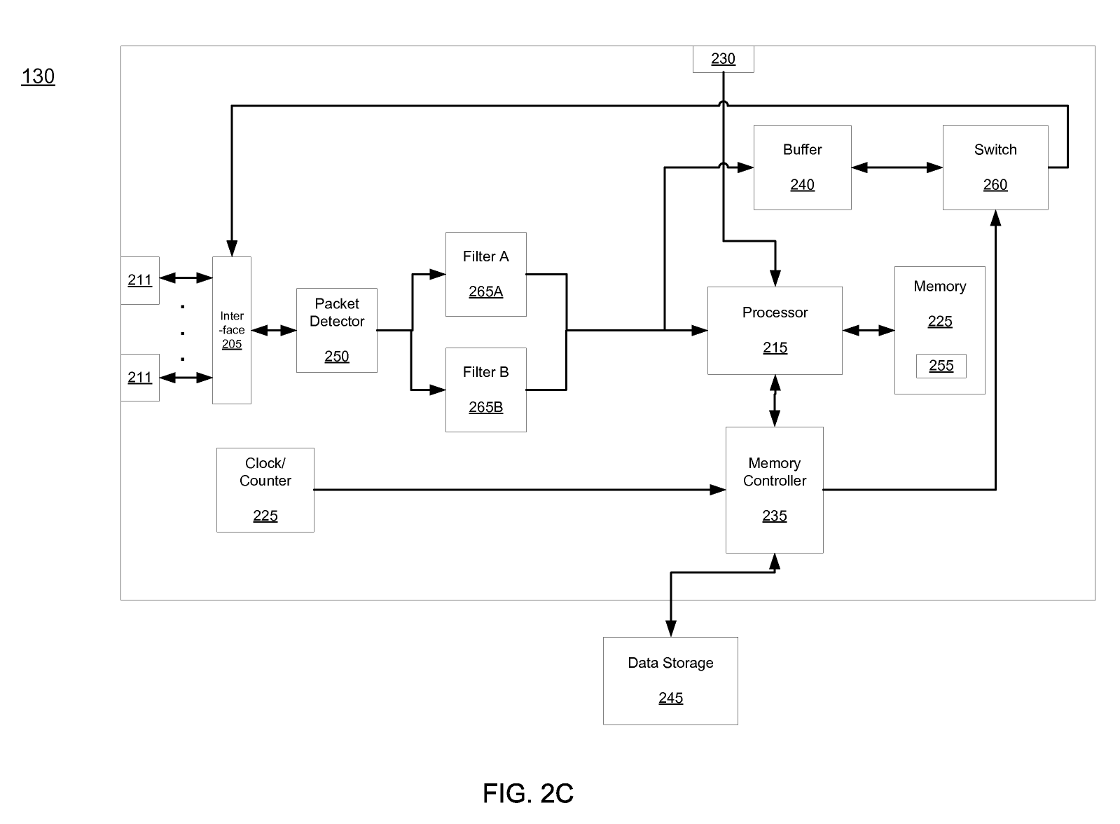

FIG. 2A is a block diagram depicting an exemplary network captured traffic distribution device 130. Network captured traffic distribution device 130 includes a plurality of ingress ports 210 and a plurality of egress ports 220. One or more egress ports 220 may be configured as a monitoring and/or stacking port. Data packets, such as data packet 140, may be received by network captured traffic distribution device 130 via one or more ingress ports 210. Data packets may be received from a source of captured traffic, such as a mirror port, like mirror port 160, and/or an inline traffic capture point, like inline traffic capture point 165. On some occasions, an ingress port 210 and/or an egress port 220 may operate bi-directionally.

In some embodiments, network captured traffic distribution device 130 may include an interface 205 communicatively coupled to one or more of ingress port(s) 210 and/or egress port(s) 220. Interface 205 may be any device capable of connecting ingress port(s) 210 and/or egress port(s) 220 to a communication link in order to facilitate communication between an external device coupled to the communication link and network captured traffic distribution device 130. Exemplary interfaces 205 include a 10G XAUI network interface.

In some embodiments, a packet detector 250 may be communicatively coupled to interface 205, a buffer 240, and/or a processor 215. Packet detector 250 may be any device enabled to detect when a captured data packet is received by network captured traffic distribution device 130 and/or interface 205 and transfer a detected captured data packet to buffer 240 and/or processor 215.

Processor 215 may be any appropriate processing device or devices enabled to execute some, or all, of the processes described herein. For example, processor 215 may be enabled to determine a portion of a captured data packet to be used for generation of a secure hash signature, generate a secure hash signature including a secure key for a captured data packet included in the traffic flow, and/or transmit the secure hash signature to memory controller 235. Processor 215 may generate a secure hash signature using conventionally available protocols and/or means, such as the Secure Hash Algorithm (SHA) (e.g., SHA-0, SHA-1, and SHA-2) or the Message-Digest Algorithm (MD5). Another means for generating a secure hash signature includes the Galois/Counter Mode (GCM) hash (GHASH) as described in, for example, the NIST Special Publication 800-38D by Morris Dworkin. In some cases, a key included in a GHASH signature may be a cryptologically secure random number chosen for an “H” parameter of the GHASH signature. In some embodiments, the secure hash signatures may include a hash-based Message Authentication Code (HMAC) RFC 2104 secure key. Generation of a secure hash signature using GHASH may, in some cases, enable the processing of a traffic flow of data packets at a relatively fast data rate (e.g., 40 gigabits per second or 100 gigabits per second.

Exemplary processors 215 include a central processing unit (CPU), an application specific integrated circuit (ASIC), and/or a field programmable gate array (FPGA). Processor 215 may be managed by, for example, a user and/or administrator, like user/administrator 155 via, for example, a management port, like management port 230. In some embodiments, packet detector 250, processor 215, memory controller 235, clock/counter 225, buffer 240, and/or switch 260 may reside in, for example, the same ASIC or FPGA or may be supplemented by a general purpose processor that may include network processors.

On some occasions, processor 215 and may execute a set of instructions 255 resident in, for example, memory 225. Memory 225 may be any appropriate data storage device or devices, like static random access memory (SRAM), dynamic random access memory (DRAM), read-only memory (ROM), flash memory, a magnetic computer storage device (e.g., hard disk, floppy disk, and magnetic tape), and optical media.

Processor 215 may also be communicatively coupled to a memory controller 235 that may operate to read data regarding previously generated secure hash signatures stored in a data storage device 245 and compare a secure hash signature for a captured data packet with the previously generated secure hash signatures associated with, for example, previously received captured data packets via, for example, a look-up function and transmit a control signal to switch 260 responsively to the comparison. For example, when the secure hash signature for a captured data packet matches a stored previously generated secure hash signature, memory controller 235 may transmit a control signal to switch 260 indicating that switch 260 should abort or otherwise stop transmission of the captured data packet to, for example, interface 205 and/or egress port 220. When the secure hash signature for a captured data packet does not match a previously generated secure hash signature, memory controller 235 may either transmit a control signal to switch 260 enabling switch 260 to transmit the captured data packet to, for example, interface 205 and/or egress port 220 or switch 260 may be configured to transmit captured data packets to, for example, interface 205 and/or egress port 220 unless a control signal is received from memory controller 235. In some embodiments, switch 260 may be configured to operate in an inverse mode and may only forward captured data packets for which a control signal is received from memory controller 235.

Data storage device 245 may be any data storage device or combination of devices configured to store previously generated secure hash signatures. Although data storage device 245 is shown to be resident outside network captured traffic distribution device 130, on some occasions it may be wholly or partially resident inside network captured traffic distribution device 130. Data storage device 245 may be, for example, content-addressable memory (CAM), dynamic random-access memory (DRAM), and static random-access memory (SRAM), and/or some combination thereof. On some occasions, memory controller 235 may be specifically adapted to interact with a type of memory included in data storage device 245.

The storage of previously generated secure hash signatures may be controlled by memory controller 235. For example, previously generated secure hash signatures may be cached in memory controller 235 and/or stored in a data storage device 245 for any length of time (e.g., from a few microseconds to a few seconds). A length of time previously generated secure hash signatures are stored in data storage device 245 may be determined by, for example, a speed of operation associated with, for example, processor 215 and/or memory controller 235, a characteristic of a secure hash signature, and/or a user specification. In some embodiments, a length of time a previously generated secure hash signature is stored in data storage device 245 may be determined with the assistance of a timing and/or counter signal received from clock/counter 225.

Clock/counter 225 may be configured to count or increment a sequence of numbers by which a sequential order in which captured data packets are received by network captured traffic distribution device 130 and/or memory controller 235 may be determined. In other embodiments, clock/counter 225 may be configured to keep conventional time in, for example, a year, month, day, and/or time of day basis. The clock values generated by clock 235 may be communicated to processor 215 in order to, for example, determine a time that a captured data packet associated with a secure hash signature is received by network captured traffic distribution device 130 and/or a component included therein. On some occasions, this determined time may then be used by, for example, memory controller 235 to associate a time stamp indicating the determined time with the captured data packet and/or secure hash signature. Although clock/counter 225 is shown as being resident inside network captured traffic distribution device 130, on some occasions, it may be resident outside network captured traffic distribution device 130 and, in some embodiments, may be a global positioning service (GPS) device.

Buffer 240 may be any data storage or buffering device enabled to temporarily store, or buffer, captured data packets or portions thereof transmitted from ingress port 210, interface 205, and/or packet detector 250. Buffer 240 may be communicatively coupled to switch 260 that may be communicatively coupled to memory controller 235 and an interface 205. Switch 260 may include, for example, one or more switches and may be, for example, an analog, digital, and/or transistor switch. Switch 260 may be configured to, for example, transfer captured data packets received from buffer 240 to interface 205 for eventual transmission to an external device via an egress port 220. On some occasions, this transmission may be influenced by a control signal transmitted by memory controller 235.

FIG. 2B is a block diagram depicting an exemplary network captured traffic distribution device 130 that is similar to the network captured traffic distribution device of FIG. 2A, with the exception that it includes one or more bi-directional ports 211 instead of ingress ports 210 and egress ports 220.

FIG. 2C is a block diagram depicting an exemplary network captured traffic distribution device 130 that is similar to the network captured traffic distribution device of FIG. 2B, with the exception that it includes a filter A 265A and a filter B 265B. Filters 265A and/or 265B may reside inside and/or outside network captured traffic distribution device 130. Filters 265A and/or 265B may be any device capable of filtering captured data packets received by network captured traffic distribution device 130 and/or system 100 according to one or more criterion. Exemplary criterion include address information included within the captured data packet, type of captured data packet, intended destination of the captured data packet, size of the captured data packet, the ingress port via which the captured data packet was received, and content included with the captured data packet. On some occasions, when a captured data packet is not removed, or filtered, from the traffic flow of captured data packets by either filter 265A or 265B, duplicate data packets may be introduced into the traffic flow of data packets transmitted to processor 215 and/or buffer 240.

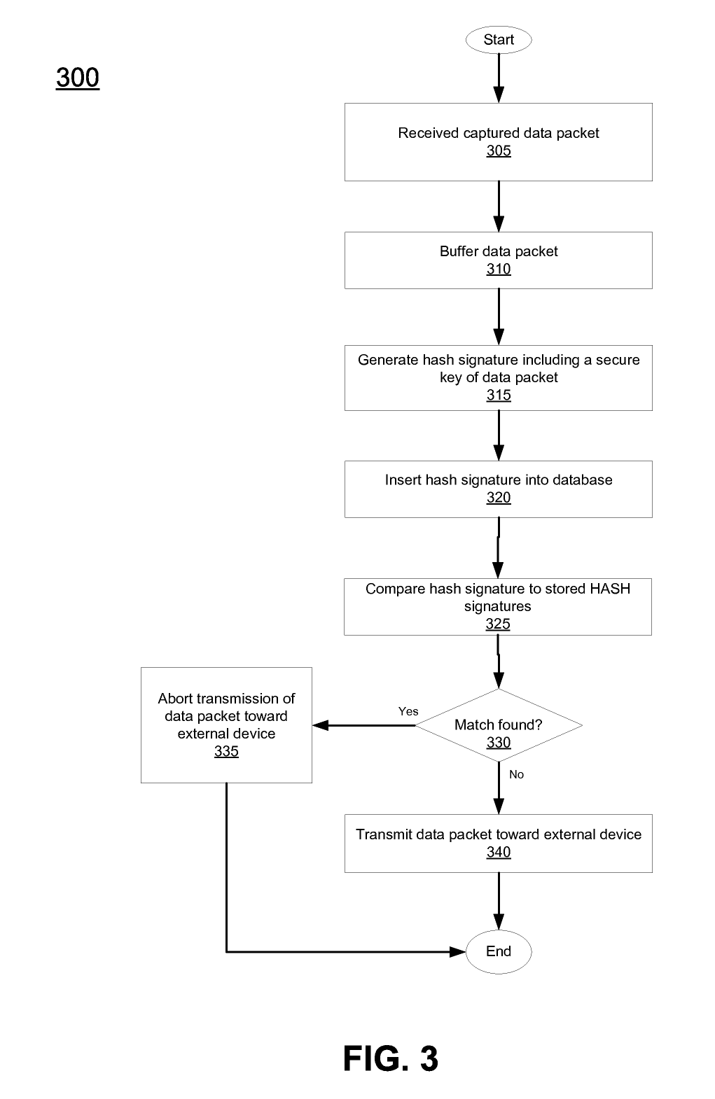

FIG. 3 is a flowchart illustrating an exemplary process 300 for removing duplicate data packets from a traffic flow of captured data packets transmitted via a communication network. Process 300 may be executed by, for example, any of the systems and/or system components disclosed herein.

In step 305, a traffic flow of captured data packets may be received at a network captured traffic distribution device, such as network captured traffic distribution device 130 via, for example, a mirror port resident on a source of the captured data packets, such as, mirror port 160 and a traffic capture point located along a communication link between two communicating devices, such as, traffic capture point 165. The traffic flow of captured data packets may be received at a rate of, for example, 1 gigabit per second, 10 gigabits per second, 40 gigabits per second, 40 gigabits per second via dense wavelength-division multiplexing, and/or 100 gigabits per second.

The traffic flow of received captured data packets and/or a captured data packet included within the traffic flow may be buffered prior to its transmission from the network capture traffic distribution device via an egress port toward an external device (step 310). The length of time the traffic flow and/or a captured data packet included within the traffic flow is buffered may depend upon, for example, a length of time required to execute one or more steps of process 300 and/or the capacity of the buffer. For example, a captured data packet, or a portion thereof, may be buffered for a length of time approximately equal to the length of time required for the performance of steps 315-325. In some cases, buffering times may be user configurable.

Next, and/or concurrently with the buffering of step 310, generation of a secure hash signature for a captured data packet may be executed (step 315). The secure hash signature may include, for example, a secure key and hash signature for the data packet. The secure hash signature may be generated by any conventionally available protocols and/or means, such as the Secure Hash Algorithm (SHA) (e.g., SHA-0, SHA-1, and SHA-2), the Message-Digest Algorithm (MD5), or GHASH. Execution of step 315 may include a determination of a portion of the captured data packet to be used for generating the hash signature and the determination of a secure key to be included in the secure hash signature.

Then, in step 320, the secure hash signature generated in step 315 may be inserted into, or otherwise stored in a database, such as data storage device 245. Next, in step 325, the secure hash signature may be compared with other previously generated and/or stored secure hash signatures that may be associated with, for example, previously received captured data packets in order to, for example, determine whether a match is found (step 330). The insertion of step 320 may be executed regardless of whether a match is found in step 330. Executing the insertion regardless of whether a match is found may enable processing a traffic flow of data packets at a faster rate than would otherwise be possible and, in some cases, may be the preferred mode of executing process 300.

When the secure hash signature generated in step 315 matches a previously generated and/or stored secure hash signature, the captured data packet may be a duplicate of a previously received captured data packet and transmission of the captured data packet to an external device may be aborted (step 335). When the secure hash signature generated in step 315 does not match a previously generated and/or stored secure hash signature, the captured data packet may not be a duplicate of a previously received captured data packet and may be transmitted toward an external device (step 340). On some occasions, step 335 and/or 340 may be executed by a memory controller, such as memory controller 235, transmitting a control signal to a switch, such as switch 260. In some embodiments, step 335 and/or 340 may be executed following the conclusion of the buffering of step 310.

Thus, methods, apparatus, and systems for removing duplicate data packets from a traffic flow of data packets transmitted via a communication network have been herein provided.

What is claimed is:

1. A network captured traffic distribution device comprising:
an ingress port configured to receive a traffic flow of captured data packets from a source of captured data packets and transmit the traffic flow of captured data packets to a processor;
an egress port configured to receive captured data packets from the processor and transmit captured data packets from the network captured traffic distribution device toward an external device via a communication network;
a memory, communicatively coupled to the memory controller and configured to store previously generated secure hash signatures;
the processor communicatively coupled to the ingress port and a memory controller and configured to receive captured data packets from the ingress port, generate a secure hash signature for a captured data packet included in the traffic flow, the secure hash signature including a secure key, and transmit the secure hash signature to the memory controller;
the memory controller, communicatively coupled to the processor, the memory, and a switch and configured to receive the secure hash signature from the processor, compare the received secure hash signature with the previously generated secure hash signatures stored in the memory, and transmit a control signal to a switch responsively to the comparison; and
the switch communicatively coupled to the memory controller and the egress port and configured to receive the control signal from the memory controller and transmit the captured data packet to the egress port responsively to the received control signal.

2. The network captured traffic distribution device of claim 1, wherein the memory includes at least one of content-addressable memory (CAM), dynamic random-access memory (DRAM), and static random-access memory (SRAM).

3. The network captured traffic distribution device of claim 1, further comprising:
a buffer communicatively coupled to the ingress port and configured to buffer the traffic flow of received captured data packets prior to receipt by the memory controller.

4. The network captured traffic distribution device of claim 1, further comprising:
a filter communicatively coupled to the processor, the filter being configured to filter the captured data packets according to at least one criterion.

5. The network captured traffic distribution device of claim 1, further comprising:
a packet detector communicatively coupled to the ingress port and the processor, the packet detector being configured to detect when a captured data packet is received by the ingress port and transfer the detected captured data packet to the processor.

6. The network captured traffic distribution device of claim 1, wherein the ingress port and the egress port are combined into a single bi-directional port.

7. A system comprising:
a network captured traffic distribution device, the network captured traffic distribution device comprising:
an ingress port configured to receive a traffic flow of captured data packets from a source of captured data packets and transmit the traffic flow of captured data packets to a processor;
an egress port configured to receive captured data packets from the processor and transmit captured data packets from the network captured traffic distribution device toward an external device via a communication network;
the processor communicatively coupled to the ingress port and a memory controller and configured to receive captured data packets from the ingress port, generate a secure hash signature for a captured data packet included in the traffic flow, the secure hash signature including a secure key, and transmit the secure hash signature to the memory controller;
the memory controller, communicatively coupled to the processor, the memory, and a switch and configured to receive the secure hash signature from the processor, compare the received secure hash signature with the previously generated secure hash signatures stored in an external data storage device, and transmit a control signal to a switch responsively to the comparison; and
the switch communicatively coupled to the memory controller and the egress port and configured to receive the control signal from the memory controller and transmit the captured data packet to the egress port responsively to the received control signal; and
the external data storage device communicatively coupled to the network captured traffic distribution device and configured to store previously generated secure hash signatures.

8. The system of claim 7, wherein the external data storage device includes at least one of content-addressable memory (CAM), dynamic random-access memory (DRAM), and static random-access memory (SRAM).

9. A method executed by a network captured traffic distribution device, the method comprising:
receiving a traffic flow of captured data packets, wherein the captured data packets are received via at least one of a mirror port resident on a source of the captured data packets and a traffic capture point located along a communication link between two communicating devices;
generating a secure hash signature for a captured data packet included in the traffic flow, the secure hash signature including a secure key;
comparing the generated secure hash signature with stored secure hash signatures; and
transmitting the captured data packet toward an external device responsively to the comparison.

10. The method of claim 9, wherein the secure hash signature is generated based upon the contents of at least one of the entire packet and a portion of the packet.

11. The method of claim 9, further comprising:
buffering the traffic flow of received captured data packets prior to at least one of the generation of the secure hash signature and the comparison.

12. The method of claim 9, further comprising:
filtering the captured data packets according to at least one criterion.
